(19) United States
(12) Patent Application Publication
(10) Pub. No.: US 2010/0024667 A1
(43) Pub. Date: Feb. 4, 2010

(54) PRESSURE-HEATING APPARATUS AND METHOD

(75) Inventor: Kazuyuki Ikura, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/472,687

(22) Filed: May 27, 2009

(30) Foreign Application Priority Data
Jul. 30, 2008 (JP) 2008-196948

(51) Int. Cl. B30B 15/34; B25J 11/00; B25J 15/00

(52) U.S. Cl. 100/38; 100/305; 414/225.01

(57) ABSTRACT

A pressure-heating apparatus includes: a stage configured to place an object to be pressure-heated thereon; a pressure-heating head arranged to oppose to the stage; and a pressure drive mechanism configured to movably support the pressure-heating head relative to said stage. The pressure-heating head includes: a plurality of pressure-heating tools; a holder configured to independently accommodate each of the pressure-heating tools; a single heater block configured to contact with ends of the pressure-heating tools to transmit a heat; and a plurality of supporters configured to independently and movably support the pressure-heating tools relative to the holder, respectively.

### CROSS-REFERENCE TO RELATED APPLICATIONS

This application is based upon and claims the benefit of priority of the prior Japanese Patent Application No. 2008-196948, filed on Jul. 30, 2008, the entire contents of which are incorporated herein by reference.

### FIELD

The embodiment discussed herein is directed to a pressure-heating apparatus for joining an electronic part to a circuit board by a joining material using a pressure-heating method.

### BACKGROUND

In recent years, digital-information home electric appliances, such as a cellular phone, a digital camera, and a digital video, have achieved a remarkable development. Electronic devices used in the digital-information home electric appliances require further improvement in miniaturization, lightness, performance, functionality and multiplicity. In order to meet such a demand, semiconductor chips have been miniaturized and a number of pins provided to the semiconductor chips has been increased. With such a progress, a pitch in arrangement of semiconductor chips has been reduced (a fine pitch arrangement). Thus, a mounting method, which can achieve such a fine pitch arrangement, has been required.

A flip-chip mounting technique, which is one of chip-bonding techniques, is considered to be a key technology to achieve a high-density, small size, high performance and low cost devices, and an application of the flip-chip mounting technique has been expanding. There are various processes in the flip-chip (FC) mounting technique depending on a material of bumps and a type of bonding. An optimum FC mounting process is selected in accordance with a form of a package.

The FC mounting technology handling a package having a pad pitch of 50 μm is more suitable for mass production due to a pressure-contacting method and a gold soldering method. However, there is a problem in these techniques that a void is generated in an under fill (UF) material after the FC mounting process. If a void is generated in the UF material, an electro migration phenomenon may occur, which short-circuits between electrodes. Thus, in order to suppress generation of voids in a heating process of the UF material, it is suggested to gelatinize the UF material in a first heating process and thereafter melt a solder in a second heating process. By gelatinizing the UF material in the first heating process, generation of voids (bubbles) in the UF material is suppressed. However, in this method, there is a problem in that a process time is two to ten times longer than a method using a one time heating process. Additionally, because a time for heating one semiconductor chip is long, a heat is transmitted to a semiconductor chip adjacent to the semiconductor chip being heated, which initiates a cure process of the UF material supplied to the adjacent semiconductor chip.

Thus, there is suggested a method of simultaneously heating a plurality of semiconductor chips while applying a pressure to the semiconductor chips (for example, refer to Patent Document 1). Also, there is suggested a method of simultaneously pressure-bonding a semiconductor chip and a flexible printed circuit board (FPC) by using a plurality of heads including a head for pressure-heating the semiconductor chip and a head for pressure-bonding the FPC (for example, refer to Patent Document 2). Further, there is suggested a method of simultaneously pressure-bonding a plurality of TAB substrates onto a crystal liquid substrate by using a plurality of heads (refer to Patent Document 3).

Patent Document 1: Japanese Laid-Open Patent Application No. 11-121532

Patent Document 2: Japanese Laid-Open Patent Application No. 2005-86145

Patent Document 3: Japanese Laid-Open Patent Application No. 06-77643

In order to simultaneously pressure-heating a plurality of semiconductor chips, a plurality of pressure-heating heads must be provided in a pressure-heating apparatus. If a pressurizing mechanism and a heating mechanism are provided to each of the pressure-heating heads, a manufacturing cost of the pressure-heating apparatus is increased.

Additionally, a space for arranging a plurality of pressure-heating heads, each having a heater, must be provided in the pressure-heating apparatus. This may prevent handling semiconductor chips arranged at a narrow pitch and semiconductor chips arranged in a plurality of rows. That is, the pressure-heating head having the pressurizing mechanism and the heating mechanism (heater) for each of the respective semiconductor chips must have a plane projection size (foot print) larger than that of each semiconductor chip. Thus, because each of the pressure-heating heads is much larger than each of the semiconductor chips arranged at a narrow pitch, the pressure-heating heads cannot be arranged at corresponding positions of the semiconductor chips.

Further, a heating temperature and a pressurizing force for each of the plurality of pressure-heating heads must be controlled independently, and, thus, a control is complicated and a maintenance operation is difficult to perform.

Therefore, it is desired to develop an improved pressure-heating apparatus, which can easily control a heating temperature and a pressurizing force for each of a plurality of pressure-heating heads independently.

### SUMMARY

According to an aspect of the invention, there is provided a pressure-heating apparatus comprising: a stage configured to place an object to be pressure-heated thereon; a pressure-heating head arranged to oppose to the stage; and a pressure drive mechanism configured to movably support the pressure-heating head relative to said stage, wherein the pressure-heating head includes: a plurality of pressure-heating tools; a holder configured to independently accommodate each of the plurality of pressure-heating tools; a single heater block configured to contact with ends of the plurality of pressure-heating tools to transmit a heat; and a plurality of supporters configured to independently and movably support the plurality of pressure-heating tools relative to the holder, respectively.

Additionally, there is provide according another aspect a pressure-heating method comprising: supporting a plurality of pressure-heating tools independently on a single holder via elastic materials; and pressing the plurality of pressure-heating tools against a plurality of objects to be pressure-heated, respectively, by moving the holder, and heating the objects to be pressure-heated by transmitting heat from the single heater block via the plurality of pressure-heating tools.

Further, there is provided according to another aspect a processed object moving apparatus configured to move an object to be processed between a first position on a vertically movable stage and a second position on an external conveyance device, comprising: a hold table configured to hold the object to be processed; an arm configured to hold the hold table; and a horizontal moving mechanism configured to horizontally move the arm, wherein the vertical moving mechanism is arranged on an opposite side of the second position relative to the first position, and the arm extends from the first position toward the second position when the hold table is at the second position.

The object and advantages of the embodiment will be realized and attained by means of the elements and combinations particularly pointed out in the appended claims.

It is to be understood that both the foregoing general description and the following detailed description are exemplary explanatory only and are not restrictive of the invention, as claimed.

### BRIEF DESCRIPTION OF DRAWINGS

FIG. 1 is a front view illustrating an outline structure of a pressure-heating apparatus according to an embodiment;

FIG. 2 is a perspective view of a pressure-heating head and a stage viewed from a bottom side;

FIG. 3 is an exploded perspective view of the pressure-heating head;

FIG. 4 is an enlarged cross-sectional view of a part of the pressure-heating head;

FIG. 5 is a cross-sectional view of a part of the pressure-heating head illustrating a state where the pressure-heating tool is pressed against a semiconductor chip;

FIG. 6 is a cross-sectional view of a part of the pressure-heating head using a coil spring as an elastic material;

FIG. 7 is a cross-sectional view of a part of the pressure-heating head in a case where a heat conductive gel is provided on an inner side of the coil spring;

FIG. 8 is a cross-sectional view of a part of the pressure-heating head in a case where a rolling contact type ball bush between an inner wall of an accommodation part of a holder and the pressure-heating tool;

FIG. 9 is a cross-sectional view of a part of the pressure-heating head in a case where a fluid such as an operating oil instead of an elastic material for generating a pressure force;

FIG. 10 is a side view illustrating a state where a substrate handler is attached to a lower base of the pressure-heating apparatus;

FIG. 11 is an exploded perspective view of a substrate table;

FIG. 12 is an outline view illustrating a positional relationship between the substrate table positioned between the pressure-heating head and a stage and a conveyance conveyor arranged near the stage;

FIG. 13 is an outline view illustrating a first operation in a series of operations of the pressure-heating head, the stage and the substrate table;

FIG. 14 is an outline view illustrating a second operation in the series of operations of the pressure-heating head, the stage and the substrate table;

FIG. 15 is an outline view illustrating a third operation in the series of operations of the pressure-heating head, the stage and the substrate table;

FIG. 16 is an outline view illustrating a fourth operation in the series of operations of the pressure-heating head, the stage and the substrate table;

FIG. 17 is an outline view illustrating a fifth operation in the series of operations of the pressure-heating head, the stage and the substrate table;

FIG. 18 is an outline view illustrating a sixth operation in the series of operations of the pressure-heating head, the stage and the substrate table;

FIG. 19 is an outline view illustrating a seventh operation in the series of operations of the pressure-heating head, the stage and the substrate table;

FIG. 20 is an outline view illustrating an eighth operation in the series of operations of the pressure-heating head, the stage and the substrate table; and

FIG. 21 is an outline view illustrating a ninth operation in the series of operations of the pressure-heating head, the stage and the substrate table.

### DESCRIPTION OF EMBODIMENT(S)

Preferred embodiment of the present invention will be explained with reference to the accompanying drawings.

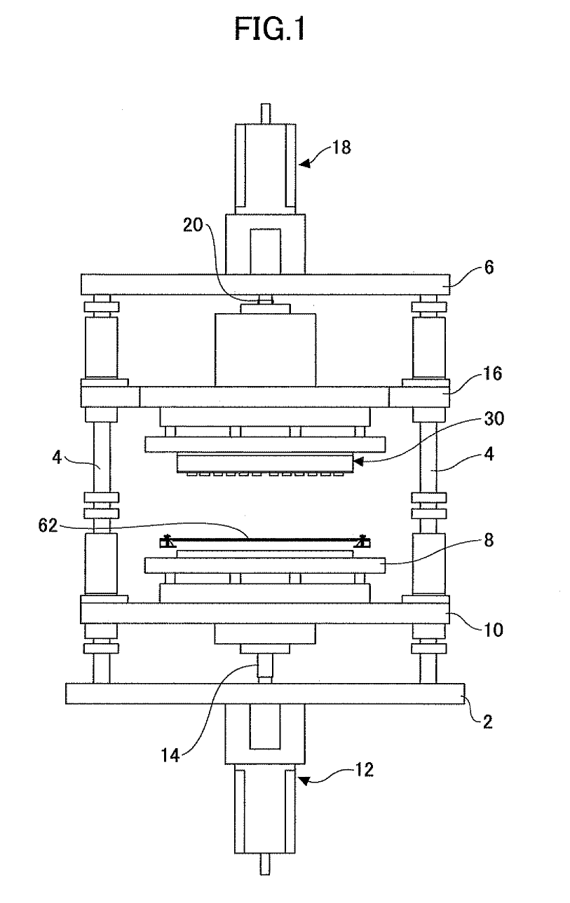

FIG. 1 is a front view illustrating an outline structure of a pressure-heating apparatus according to an embodiment. The pressure-heating apparatus includes a lower base 2, a plurality of guide rods 4 extending vertically from the lower base 2, and an upper base 6 to which ends of the guide rods 4 are fixed.

On the side of the lower base 2, a stage support plate 10 to which a stage 8 is attached is provided movably along the guide rods 4. A stage drive motor 12 is attached to the lower base 2. The rotational shaft of the stage drive motor 12 is connected to a ball screw 14 attached to the stage support plate 10. By driving the stage drive motor 12 to drive the ball screw 14, the stage 8 is movable up and down together with the stage support plate 10. A vertical movement of the stage 8 may be performed using an air cylinder, a hydraulic cylinder or a cam mechanism other than the combination of the stage drive motor 12 and the ball screw 14.

On the other hand, on the side of the upper base 6, a head support plate 16 to which a pressure-heating head 30 is attached is provided movably along the guide rods 4. A head drive motor 18 is attached to the upper base 6. The rotational shaft of the head drive motor 18 is connected to a ball screw 20 attached to the head support plate 16. By driving the head drive motor 18 to drive the ball screw 20, the pressure-heating head 30 is movable up and down together with the head support plate 16. The vertical movement of the pressure-heating head 30 may be performed using an air cylinder, a hydraulic cylinder or a cam mechanism other than the combination of the head drive motor 18 and the ball screw 20.

The pressure-heating apparatus having the above-mentioned structure is an apparatus for collectively pressurizing and heating a plurality of semiconductor chips arranged on a substrate. Specifically, the semiconductor chips are fixed to the substrate by heating and curing an under fill material by heating the semiconductor chips by the pressure-heating head 30 while pressing the pressure-heating head 30 onto the semiconductor chips from above.

In addition, a substrate handler is provided near the pressure-heating apparatus so as to place the substrate on the stage 8. In FIG. 1, a substrate table 62 of the substrate handler is illustrated in an upper portion. The structure and operations of the substrate handler will be described later.

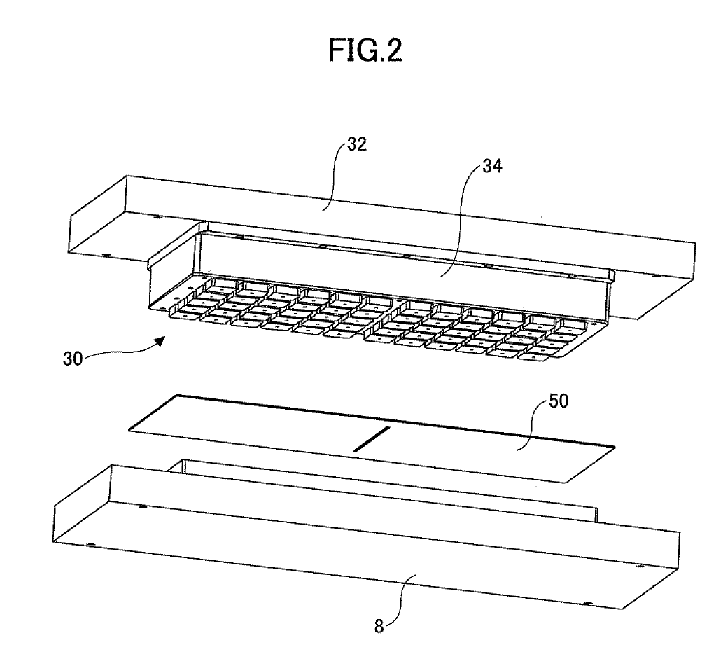

FIG. 2 is a perspective view of the pressure-heating head 30 and the stage 8 viewed from a bottom side. The pressure-heating head 30 includes a heater block 32 and a holder 34 attached to the heater block 32. The heater block 32 is a single block formed of a heat conductive material such as, for example, copper. An electric heater (not illustrated in the figure) is provided in the heater block 32. The heater block 32 can be heated by supplying an electric power to the electric heater. The holder 34 is also formed of a heat conductive material such as, for example, copper. It is preferable to apply, for example, nickel plating to surfaces of the heater block 32 and the holder 34.

The stage 8 to which the pressure-heating head 30 faces is a block having a flat surface and formed of, for example, a stainless steel. An electric heater may be provided inside the stage 8. A substrate 50 placed on the stage 8 can be heated by heating the stage 8 by supplying an electric power to the electric heater.

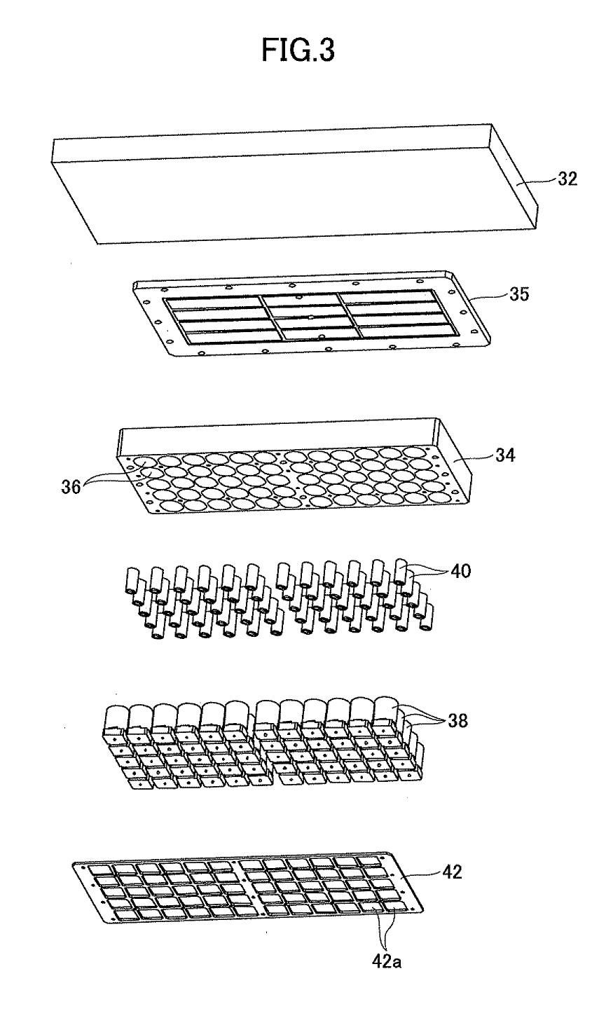

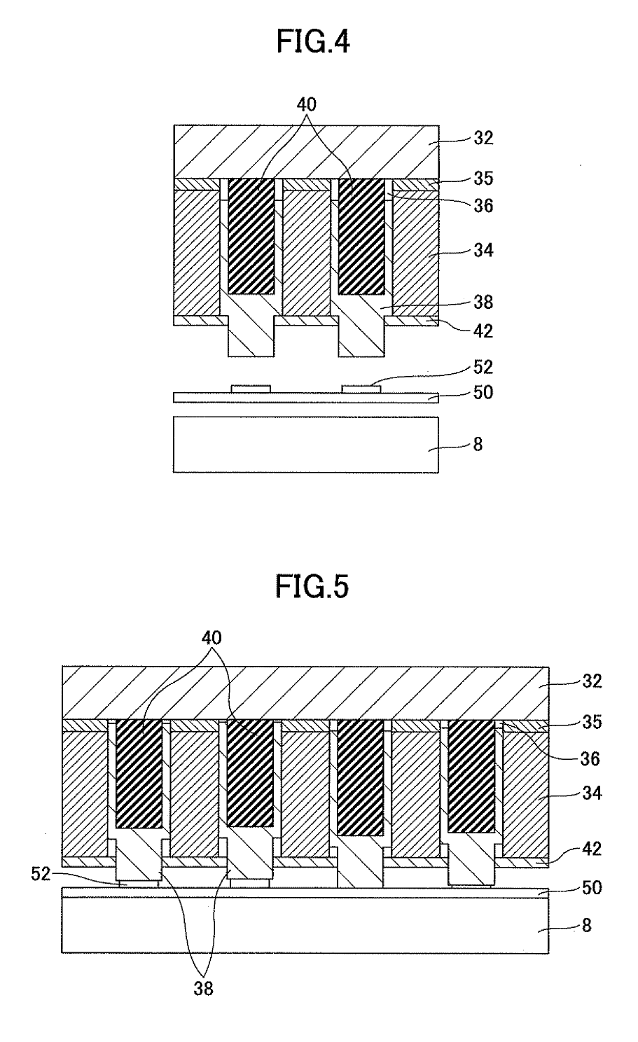

FIG. 3 is an exploded perspective view of the pressure-heating head 30. FIG. 4 is an enlarged cross-sectional view of the pressure-heating head 30.

The holder 34 is attached to the heater block 32 through a holder attachment plate 35. The holder attachment plate 35 is not always necessarily provided, and may be integrally formed with the holder 34. A plurality of accommodation parts 36 are formed in the holder 34. The accommodation parts 36 penetrate the holder 34 and extend between the top and bottom surfaces of the holder 34. The arrangement of the accommodation parts 36 corresponds to the arrangement of the semiconductor chips 52 on the substrate, which is an object to be pressure-heated.

Pressure-heating tools 38 are accommodated in the accommodation parts 36, respectively. Each of the accommodation parts 36 is formed by a cylindrical penetrating hole. Each of the pressure-heating tools 38 is formed in a cylindrical shape so that the pressure-heating tools 36 are slidable on inner walls of the accommodation parts 36, respectively. A square flat part is formed on an end of each of the pressure-heating tools 38 so as to press the semiconductor chips 52. The pressure-heating tools 38 are formed of a heat conductive material such as, for example, copper.

An upper end of each of the pressure-heating tools 38 forms a cavity so that an elastic material 40 as a supporter is accommodated in the cavity. A portion of the elastic material 40 extends from an extreme end of the pressure-heating tool 38, and an upper end of the elastic material 40 is brought into contact with the heater block 32 in a state where the pressure-heating tool 38 is accommodated in the accommodation part 36 of the holder 34. That is, the pressure-heating tools 38 are set in a state where the pressure-heating tools 38 are attached to the heater block 32 via the respective elastic materials 40.

The pressure-heating tools 38 attached with the elastic materials 40 are accommodated in the accommodation parts 36, respectively, and a cover 42 is attached to the bottom surface of the holder 34. Openings 42a are provided in the cover 42 so that the extreme ends of the pressure-heating tools 38 protrude from the cover 42.

When the pressure-heating head 30 having the above-mentioned structure is moved toward the substrate 50 on the stage 8 and the extreme ends of the pressure-heating tool 38 are pressed onto the semiconductor chips 52, the elastic materials 40 are compressed and the pressure-heating tools 38 are elastically moved (displaced) relative to the holder 34. The movable distance of the pressure-heating tools 38 may be a degree that can absorb a variation in heights from the surface of the substrate 50 to the top surfaces of the semiconductor chips 52. For example, if the thicknesses of the semiconductor chips are 0.05 mm to 0.3 mm, sufficient movable distances of the pressure-heating tools 38 may be 1 mm to 2 mm. Because the pressure forces by the pressure-heating tools 38 are determined by elastic forces of the elastic materials 40, what is required is to set movable distances (strokes) with which a desired pressure force can be applied to each of the semiconductor chips 52.

FIG. 5 is a cross-sectional view of a part of the pressure-heating head 30 illustrating a state where the pressure-heating tools 38 are pressed against the semiconductor chips 52. Even if there is a variation in the heights of the semiconductor chips 52, the variation is absorbed due to the elastic materials 40 being compressed and elastically deformed. Thus, each of the semiconductor chips 52 can be pressed with a desired pressure force by the pressure-heating tools 38. In a portion where the semiconductor chips 52 do no exist, the pressure-heating tools 38 are brought into contact with the surface of the substrate 50.

Because the pressure-heating tools 38 are provided to the semiconductor chips 52 on one-to-one basis, each of the pressure-heating tool 38 can be moved (displaced) independently, which allows each of the semiconductor chips 52 being pressed independently. According to the above-mentioned mechanism, a variation in the heights of the semiconductor chips 52 can be absorbed.

Since the elastic materials 40 are brought into contact with the heater block 32, it is desirable to form the elastic materials 40 by an elastic material having a heat resistance. Although the elastic materials 40 are formed of a polyurethane rubber in the present embodiment, the elastic materials 40 is not limited to an elastic material such as a rubber or a plastic, and a gelatinized material such as a silicon gel or a metal made spring may be used.

The pressure-heating tools 38 has not only the function to press the semiconductor chips 52 but also a function to heat an under fill material or a solder between the semiconductor chips 52 and the substrate 50 by heating the semiconductor chips 52.

The heater block 32 is provided with a heater so that the heater block 32 can be heated by the heater. When the heater block 32 is heated, the heat is transmitted to the pressure-heating tools 38 through the copper made holder 34, and the extreme ends of the pressure-heating tools 38 are also heated. Accordingly, the semiconductor chips 52 pressed by the extreme ends of the pressure-heating tools 38 are also heated, which results in the under fill material and the solder under the semiconductor chips 52 being heated.

According to the present embodiment, there is no need to provide a heater to each of the plurality of pressure-heating tools 38, and the pressure-heating tools 38 are heated by transmitting heat from the single heater block 32 to the pressure-heating tools 38. Thus, the heating mechanism is simplified and the control of heating can be performed by merely performing a control of the heater to heat the heater block 32.

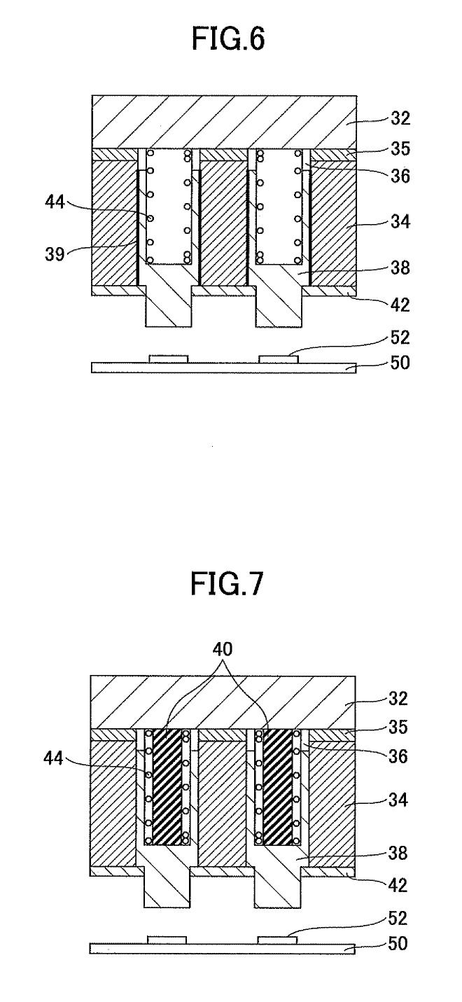

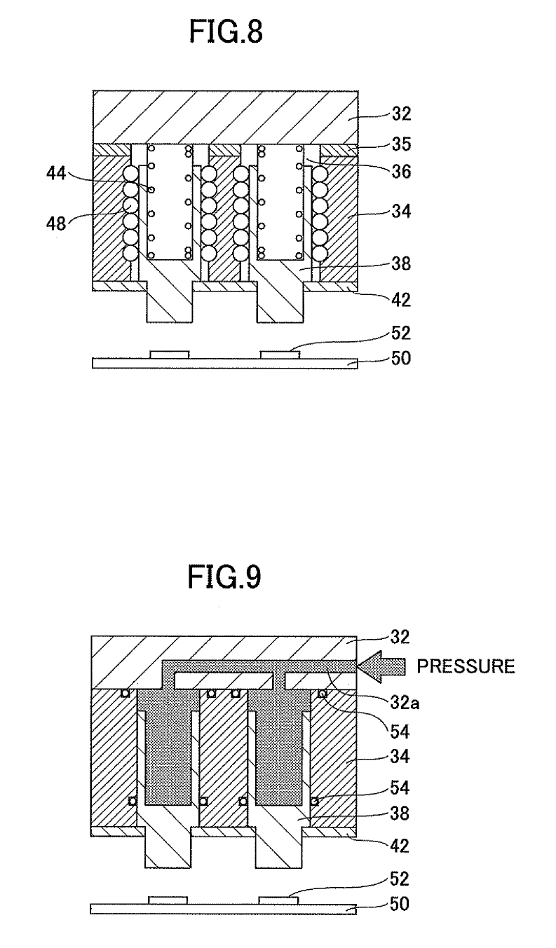

The elastic body 40 is not limited to a polyurethane rubber, and can be formed using various elastic materials. FIG. 6 is a cross-sectional view of a part of the pressure-heating head 30 using a metal coil spring 44 as an elastic material. By using the metal coil spring 44 as an elastic material, a heat generated by the heater block 32 can be transmitted to the pressure-heating tool 38 through the metal coil spring 44. The heat transfer characteristic may be improved by providing a heat-conducting oil between the inner wall of the accommodation part 36 of the holder 34 and the outer circumferential surface of the pressure-heating tool 38. Moreover, as illustrated in FIG. 7, an elastic material 46 such as a heat-conducting gel having a good heat-conducting characteristic may be provided inside the coil spring 44 so as to improve the heat transfer to the pressure-heating tool 38. Moreover, as illustrated in FIG. 8, a rolling contact type ball bush 48 may be provided between the inner wall of the accommodation part 36 of the holder 34 and the outer circumferential surface of the pressure-heating tool 38 in order to further improve the heat transfer to the pressure-heating tool 38.

FIG. 9 is a cross-sectional view of a part of the pressure-heating head 38 using a fluid such as an operating oil instead of an elastic material for generating a pressure force. The circumference of the accommodation part 36 formed in the holder 34 is sealed by a seal material 54 such as an O-ring, and a fluid (liquid) 56 such as an operating oil is filled in the accommodation part 36. The fluid 56 can be filled in the accommodation part 36 by supplying the fluid 56 through a passage 32a formed in the heater block 32. The semiconductor chip 52 can be pressed by pressurizing the fluid 56 in the accommodation part 36 in a state where the extreme end of the pressure-heating tool 38 is in contact with the semiconductor chip 52. If the fluid 56 has a good heat transfer characteristic, a heat generated in the heater block can be efficiently transferred to the pressure-heating tool 38 through the fluid 56.

A description will be given below of a substrate handler, which is a substrate moving device for placing the substrate 50 on the stage 8.

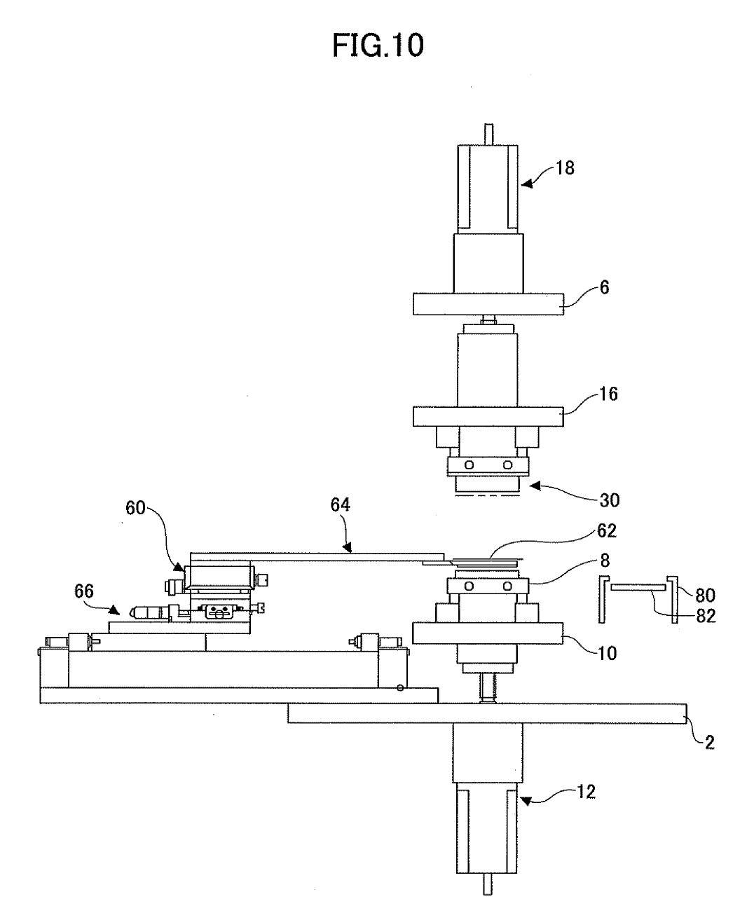

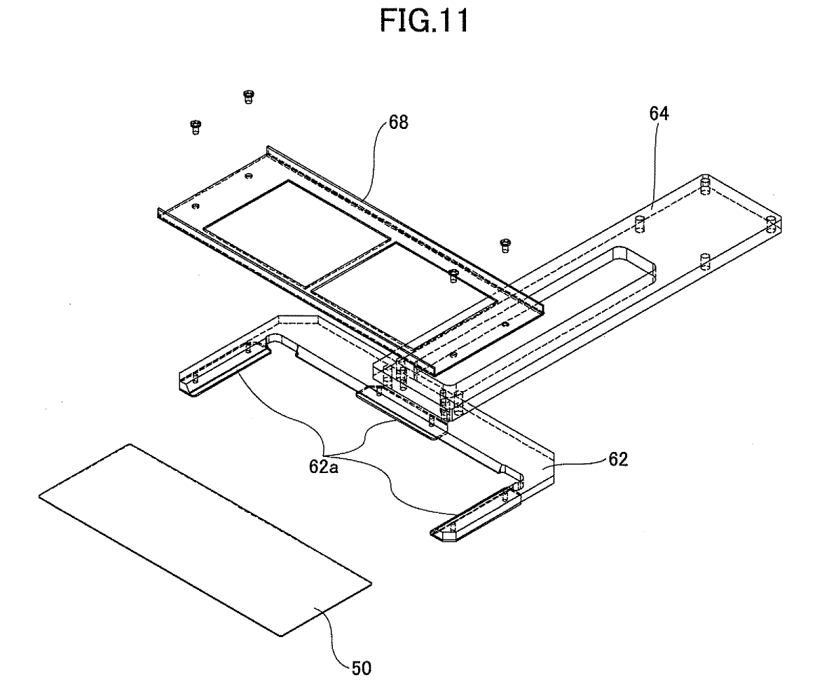

FIG. 10 is a side view illustrating a state where a substrate handler 60 is attached to the lower base 2 of the pressure-heating apparatus. In FIG. 10, illustration of the guide rods 4 of the pressure-heating apparatus is omitted for the sake of simplification of the drawing. The substrate handler 60 is a substrate transfer device that picks up the substrate 50 being conveyed by a conveyance conveyer 80, which is an external conveyance device, and places the substrate 50 on the stage 8. Also, the substrate handler 60 picks up the substrate 50 on the stage 8, and returns the substrate 50 to the conveyance conveyer 80.

The substrate handler 60 has a substrate table 62 for holding the picked up substrate 50. The substrate table 62, which is a hold table for holding the substrate, is fixed to an arm 64 driven by an arm drive mechanism 66. The arm 64 can move the substrate table 62 between a second position on the conveyance conveyer 80 and a first position on the stage 8 by horizontally moving in left-to-right and right-to-left directions in FIG. 10. The operation of picking up the substrate 50 is performed by vertical movements of a substrate lifter 82 provided under the conveyance conveyer 80 and a vertical movement of the stage 8. Thus, the substrate table 62 merely moves in a horizontal direction.

FIG. 11 is an exploded perspective view of the substrate table 62. The substrate table 62 is a channel-shaped frame member and a substrate engaging part 62a is provided on each of the three inner sides of the channel shape. The substrate engaging parts 62 are brought into engagement with three sides of the substrate 50 to hold the substrate 50. An upper guide 68 is provided in an upper portion of the substrate table 62. The upper guide 68 is a press member for pressing and fixing the substrate 50 when the substrate 50, which is held by the substrate engaging parts 62a, is lifted up by the stage 8. In FIG. 10, the substrate table 62 is arranged in a state where the open side of the channel shape faces the conveyance conveyer 80.

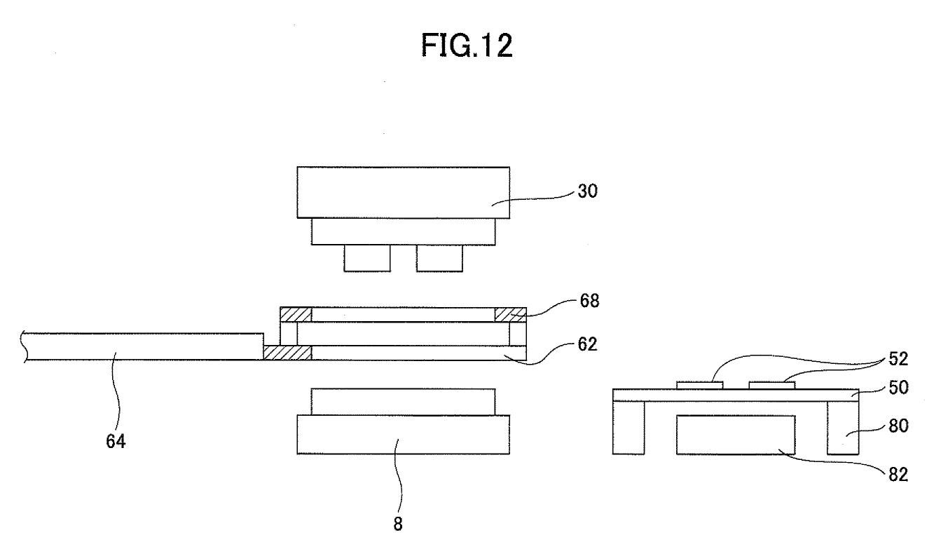

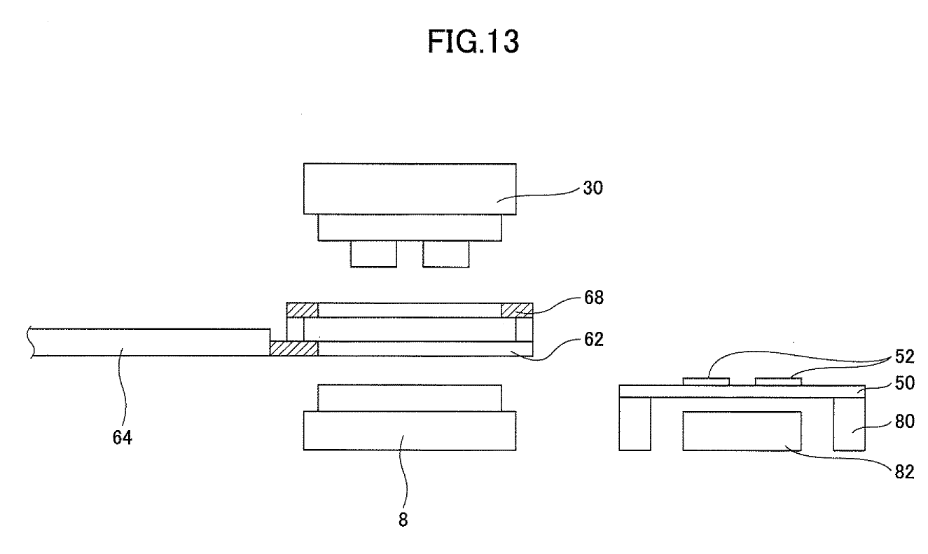

FIG. 12 is an outline view illustrating a positional relationship between the substrate table 62 positioned between the pressure-heating head 30 and the stage 8 and the conveyance conveyer 80 positioned near the stage 8. A description will be given below, with reference to FIG. 12, of operations of the substrate handler 60. FIGS. 13 through 21 are outline views illustrating a series of operations of the pressure-heating head 30, the stage 8 and the substrate table 62.

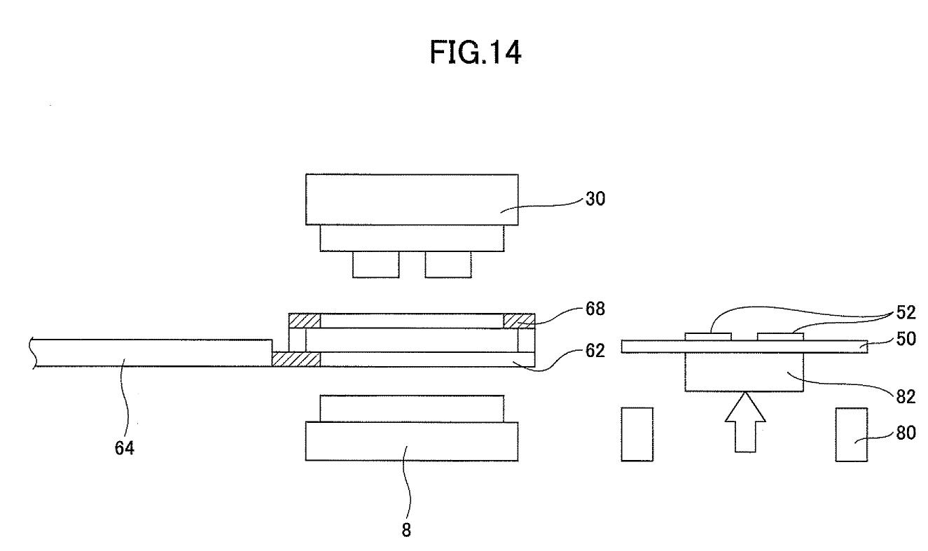

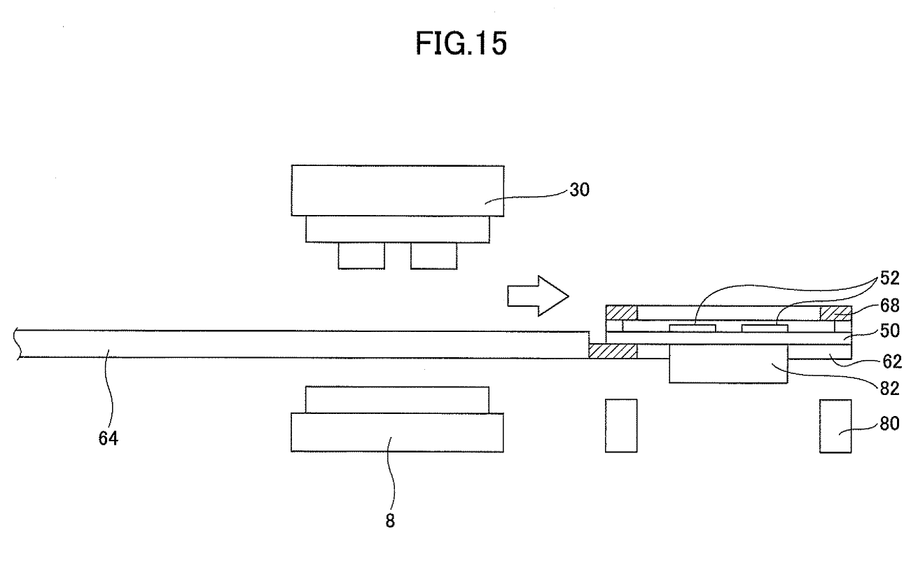

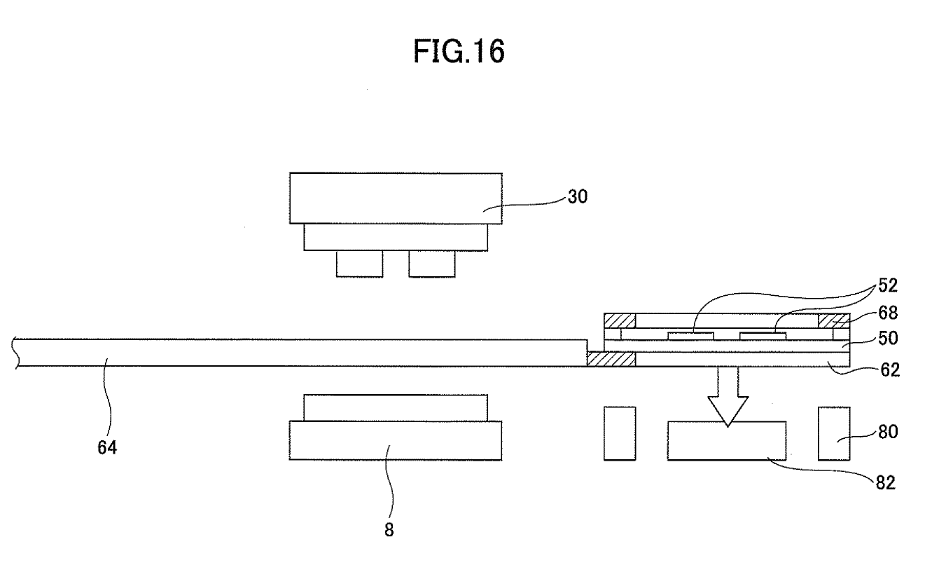

First, as illustrated in FIG. 13, the substrate 50 on which semiconductor chips are placed is conveyed by the conveyance conveyer 80, and located at a position where the substrate 50 is picked up. Then, as illustrated in FIG. 14, the substrate lifter 82 under the conveyance conveyer 80 moves up to lift the substrate 50. The vertical position of the substrate 50 in this state is slightly higher than the substrate engaging parts 62a of the substrate table 62. Then, as illustrated in the FIG. 15, the substrate table 62 moves horizontally and substrate engaging parts 62a move to a position under the substrate 50. Then, as illustrated in the FIG. 16, the substrate lifter 82 moves down, which results in a state where the substrate 50 is in engagement with and held by the substrate engaging parts 62a.

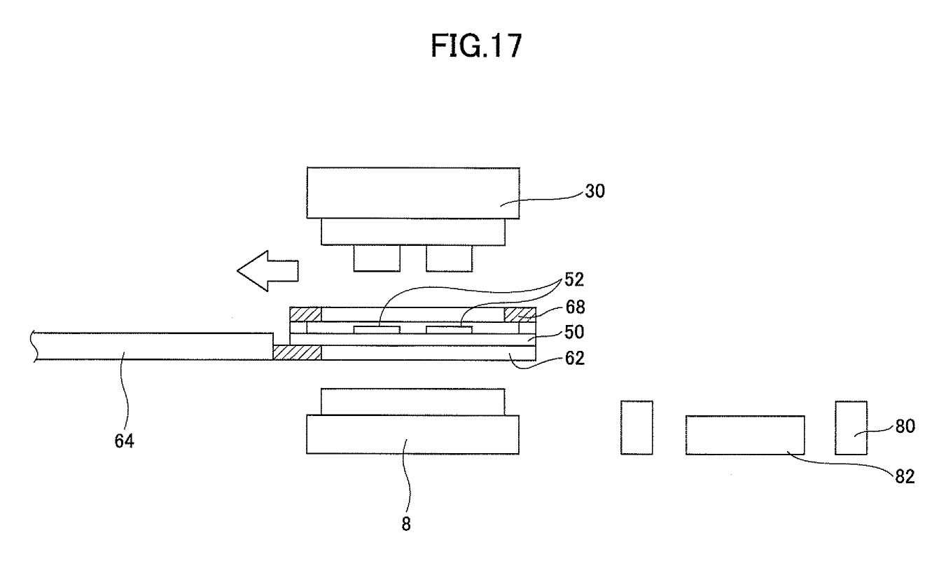

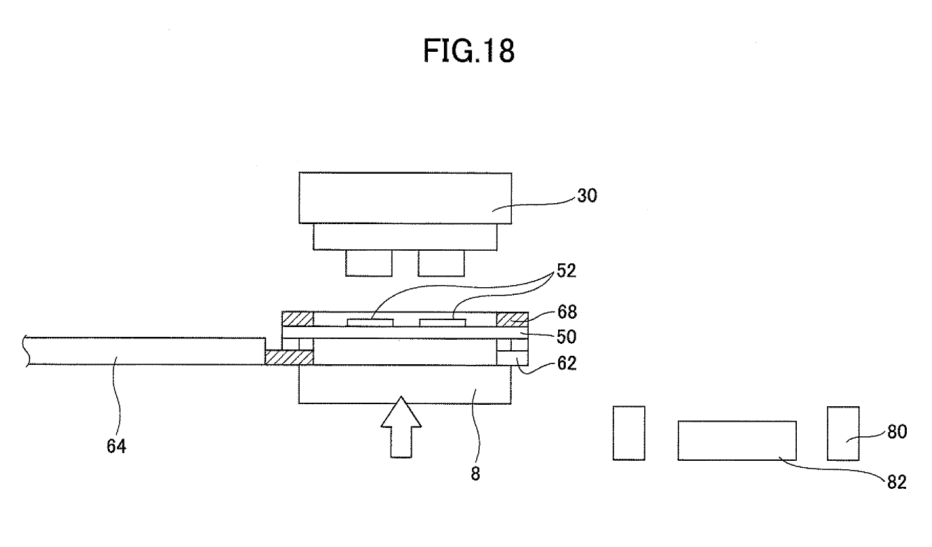

Then, the substrate table 62 moves horizontally to a position above the stage 8, as illustrated in FIG. 17, while holding the substrate 50. Then, as illustrated in FIG. 18, the stage 8 moves up and the substrate 50 is placed on the stage 8. In this state, the substrate 50 is pressed onto the stage 8 by the upper guide 68 so as to prevent the substrate 50 from being lifted due to warping. The under fill material supplied to the substrate 50 is heated by a heat from the stage 8. This heating process is a first heating process, and a heating temperature and a heating time are set so that the under fill material is not completely cured and stays in a gelatinized state.

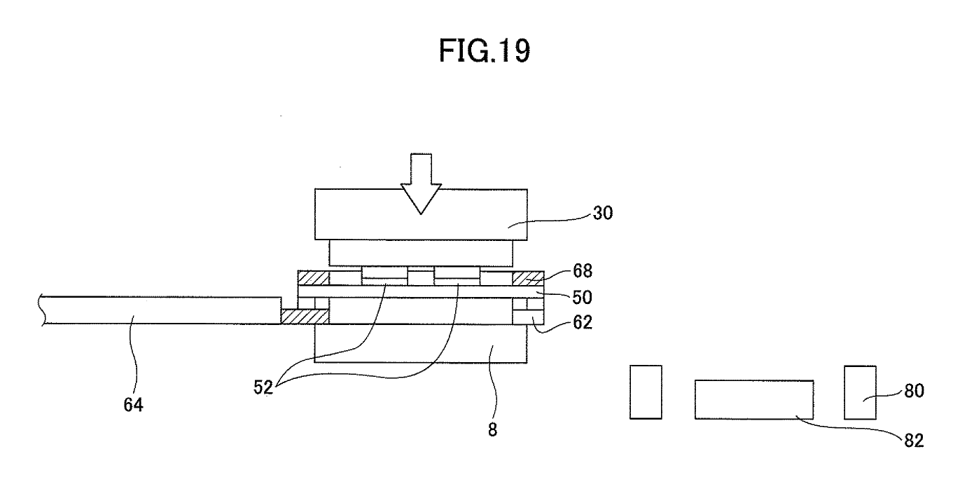

After the first heating process is completed, the pressure-heating head 30 moves down, as illustrated in FIG. 19, and a second heating process is performed while the plurality of semiconductor chips 52 are simultaneously pressed by the plurality of pressure-heating tools 38. In the second heating process, the under fill material under the semiconductor chips 52 is cured by simultaneously heating the plurality of semiconductor chips 52 by the heat from the plurality of pressure-heating tools 38. If solder bonding is used, a solder is melted in the second heating process.

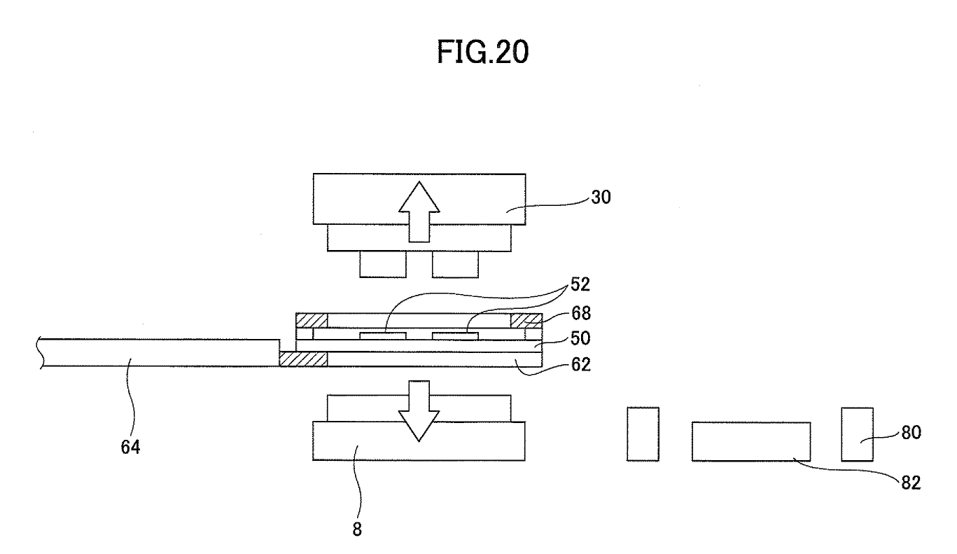

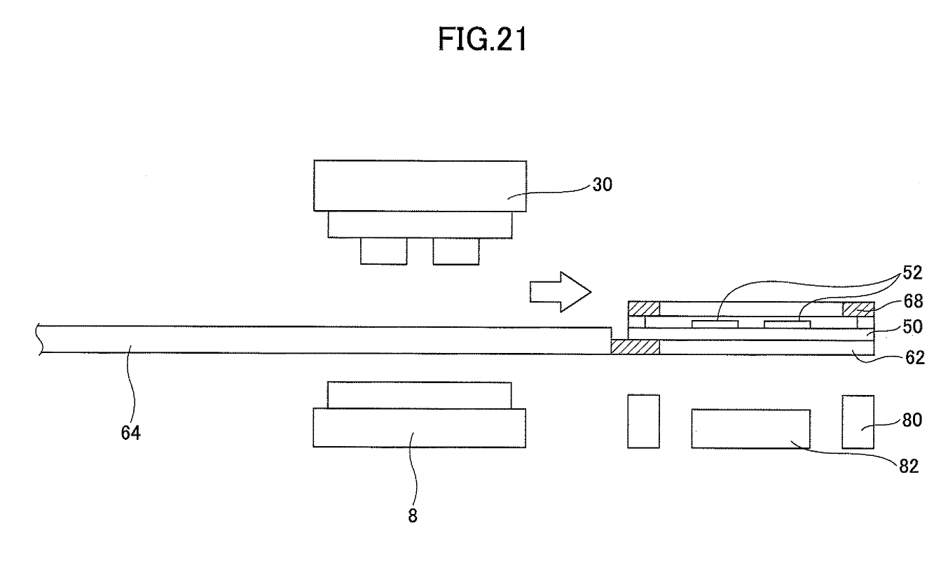

After completion of the second heating process, the pressure-heating head 30 is moved up and stage 8 are moved down as illustrated in FIG. 20. When the stage 8 is moved down, the substrate 50 is brought into engagement with the substrate engaging parts 62a of the substrate table 62, and is held by the substrate table 62. Then, as illustrated in FIG. 21, the substrate table 62 moves horizontally to a position above the conveyance conveyer 80. Thereafter, the substrate lifter 82 moves up to lift up the substrate slightly, and the substrate table 62 moves rearward and the substrate lifter 82 moves down. Thereby, the substrate 50 is placed on the conveyance conveyer 80 and is conveyed to a subsequent process.

It should be noted that although the above-mentioned substrate handler 60 is provided as a part of the pressure-heating apparatus, the substrate handler 60 can be used for moving an object to be processed such as a substrate in association with a processing apparatus other than the pressure-heating apparatus. For example, the substrate handler 60 may be used in a bonding apparatus as a processing apparatus to move a substrate, which is an object to be processed, between a first position on a bonding stage and a second position on a conveyance apparatus.

All examples and conditional language recited herein are intended for pedagogical purposes to aid the reader in understanding the principles of the invention and the concepts contributed by the inventor to furthering the art, and are to be construed a being without limitation to such specifically recited examples and conditions, nor does the organization of such examples in the specification relates to a showing of the superiority and inferiority of the invention. Although the embodiment(s) of the present invention (s) has(have) been described in detail, it should be understood that the various changes, substitutions, and alterations could be made hereto without departing from the spirit and scope of the invention.

What is claimed is:

1. A pressure-heating apparatus comprising:
a stage configured to place an object to be pressure-heated thereon;
a pressure-heating head arranged to oppose to the stage; and
a pressure drive mechanism configured to movably support the pressure-heating head relative to said stage,
wherein said pressure-heating head includes:
a plurality of pressure-heating tools;
a holder configured to independently accommodate each of the plurality of pressure-heating tools;
a single heater block configured to contact with ends of said plurality of pressure-heating tools to transmit a heat; and
a plurality of supporters configured to independently and movably support said plurality of pressure-heating tools relative to the holder, respectively.

2. The pressure-heating apparatus according to claim 1, wherein said pressure-heating tools are slidably accommodated in a plurality of accommodation parts penetrating through said holder, respectively, and said plurality of supporters are accommodated in the accommodation parts together with said pressure-heating tools, respectively.

3. The pressure-heating apparatus according to claim 2, wherein said plurality of supporters are elastic materials arranged between said heater block and said pressure-heating tools, and are configured to elastically support said pressure-heating tools.

4. The pressure-heating apparatus according to claim 3, wherein said elastic materials are rubber members arranged between said heater block and said pressure-heating tools.

5. The pressure-heating apparatus according to claim 3, wherein said elastic materials are metal coil springs arranged between said heater block and said pressure-heating tools.

6. The pressure-heating apparatus according to claim 3, wherein a heat-conducting oil is supplied between each of said pressure-heating tools and an inner wall of respective one of said accommodation parts of said holder.

7. The pressure-heating apparatus according to claim 2, wherein each of said supporter is a liquid sealed in respective one of said accommodation parts.

8. The pressure-heating apparatus according to claim 1, wherein a heater is provided to said stage.

9. The pressure-heating apparatus according to claim 1, wherein said pressure-heating tools, said heater block and said holder are formed of copper.

10. The pressure-heating apparatus according to claim 1, further comprising:
a vertical moving mechanism configured to move said stage up and down; and
a pressure-heated object moving device configured to move said object to be pressure-heated between a first position on said stage and a second position on an external conveyance device.

11. The pressure-heating apparatus according to claim 10, wherein said pressure-heated object moving device includes:
a hold table configured to hold said object to be pressure-heated;
an arm configured to hold the hold table; and
a horizontal moving mechanism configured to horizontally move the arm,
wherein said vertical moving mechanism is arranged on an opposite side of said second position relative to said first position, and said arm extends from said first position toward said second position when said hold table is at said second position.

12. The pressure-heating apparatus according to claim 11, wherein said hold table is a channel-shaped member having one open side facing said second position and having an engaging part, which engages with said object to be pressure-heated, on each of other three sides.

13. The pressure-heating apparatus according to claim 12, wherein said pressure-heated object moving device further includes a press member provided above said hold table and presses said object to be pressure-heated against said stage when said object to be pressure-heated is placed on said stage.

14. A pressure-heating method comprising:
supporting a plurality of pressure-heating tools independently on a single holder via elastic materials; and
pressing said plurality of pressure-heating tools against a plurality of objects to be pressure-heated, respectively, by moving the holder, and heating the objects to be pressure-heated by transmitting heat from the single heater block via said plurality of pressure-heating tools.

15. A processed object moving apparatus configured to move an object to be processed between a first position on a vertically movable stage and a second position on an external conveyance device, comprising:
a hold table configured to hold said object to be processed;
an arm configured to hold the hold table; and
a horizontal moving mechanism configured to horizontally move the arm,
wherein said vertical moving mechanism is arranged on an opposite side of said second position relative to said first position, and said arm extends from said first position toward said second position when said hold table is at said second position.

16. The processed object moving apparatus as claimed in claim 15, wherein said hold table is a channel-shaped member having one open side facing said second position and having an engaging part, which engages with said object to be processed, on each of other three sides.

17. The processed object moving apparatus according to claim 16, further including a press member provided above said hold table and presses said object to be processed against said stage when said object to be processed is placed on said stage.
